(19) United States
(12) Patent Application Publication
(10) Pub. No.: US 2008/0319772 A1
(43) Pub. Date: Dec. 25, 2008

(54) SYSTEM AND BUSINESS METHOD FOR LEASING A MOLD

(76) Inventor: Michael G. Eikenberry, Russiaville, IN (US)

Correspondence Address: FOLEY & LARDNER LLP, 777 EAST WISCONSIN AVENUE, MILWAUKEE, WI, 53202-5306, US

(21) Appl. No.: 11/766,688

(22) Filed: Jun. 21, 2007

(51) Int. Cl. G06Q 30/00

(52) U.S. Cl. 705/1

(57) ABSTRACT

A method for managing a lease purchase program includes a computing system, a network, one or more databases, and a server. The server provides a sales proposal operation, a mold design operation, a mold construction operation, a completed sales operation, and/or a payment schedule operation for a mold lease purchase.

### FIELD

The present disclosure relates generally to the field of an electronic business method as it relates to injection or insert molds. The disclosure more specifically relates to a method of generating a purchase lease program for injection or insert molds.

### BACKGROUND

Injection and insert molds for the plastic industry have traditionally been designed, manufactured, and sold to customers for a purchase price. If any user purchase financing is utilized, it has traditionally been up to the business purchasing the mold to pursue a financial program.

As computer systems became more common, financial knowledge as well as customer proposal and other data records, were transferred to computers as centralized access points. Computer systems allow for standardized communication of customer information and customer records.

Leasing programs provide a financial tool to offer customers an optional purchase plan. A lease is the right to use real property, or capital equipment, given by a lessor to another person, or the lessee, for a fixed or indefinite period of time. During this time, the lessee obtains exclusive possession of the property in return for paying the lessor a fixed payment. A lease may be a fixed-term agreement for a specified period of time or a periodic agreement which renews automatically, usually on a monthly or weekly basis. Businesses often choose to lease capital purchases to improve cash flow.

A leasing program allows the purchaser to conserve cash reserves and leverage up the buying power of their operating or capital budget limitations. By financing capital equipment through a lease, 100% financing is achieved, or in other words, no down payment is required. In many cases, leasing provides income tax benefits as the assets purchased do not appear on the asset portion of the balance sheet. Therefore, debt-to-equity ratios are unaffected.

Additionally, a leasing program allows a user to match revenues with expenditures by paying for the capital purchase while it is used to generate revenue and protect profits. Valuable cash and credit lines are preserved to grow the user's business.

Lease application processes are simple and convenient. Credit approval and lease documentation is uncomplicated and can be completed very quickly. The user may tailor repayments to match their cash flow and keep budgeting simple. Fixed payments over the term of the lease allows the user to balance their budget.

Therefore, there is a need for a business method to purchase injection and insert molds utilizing leasing. There is also a need for a business method for purchasing injection and insert molds to be efficient, simple, and accurate. There is also a need for a business method for purchasing injection and insert molds to be in a standard format to facilitate the information exchange of customer and mold purchase information.

### SUMMARY

An exemplary embodiment relates to a method for managing a lease purchase program for a mold. The lease purchase program includes a computing system, a network, one or more databases, and a server. The server is configured to provide a sales proposal operation, a mold design operation, a mold construction operation, a completed sales operation, and/or a payment schedule operation.

According to another embodiment, a method for managing a lease purchase program includes the following computer-implemented steps: generating a purchase order; receiving a customer application; and receiving information related to a sampled and approved mold.

According to yet another embodiment, a lease purchase plan system for a mold includes a means for managing customer data, a means for managing a lease purchase program for a mold, and a means for communicating the lease purchase program to a customer.

### BRIEF DESCRIPTION OF THE DRAWINGS

FIG. 1 is a block diagram of a lease purchase plan system according to one exemplary embodiment.

FIG. 2 is a process flow diagram illustrating a process to manage customer information and to generate an efficient and accurate leasing program according to one exemplary embodiment.

FIG. 3 is a process flow diagram illustrating the details for the method of FIG. 2 according to another exemplary embodiment.

FIG. 4 is a schematic diagram illustrating entities that may communicate or access customer records of a user via the system of FIG. 1, according to yet another exemplary embodiment.

FIG. 5 is a schematic diagram illustrating administrator management of the system of FIG. 1 according to still another exemplary embodiment.

FIG. 6 is a lease application for the system of FIG. 1 according to a further exemplary embodiment.

### DESCRIPTION

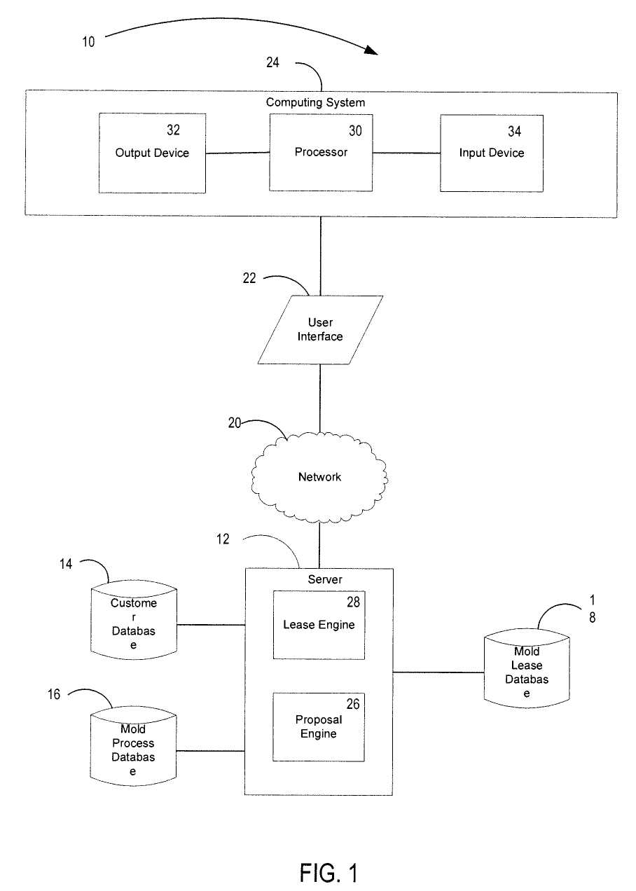

Referring to FIG. 1, a system 10 is configured to manage a lease purchase program provided to a customer. In an embodiment, system 10 can be configured to provide a sales proposal operation, an injection mold design operation, a mold construction operation, a completed sales operation, and a payment schedule operation. System 10 generally includes a server 12, a customer database 14, a mold process database 16, an injection mold lease database 18, a network 20, a user interface 22, and a computing system 24.

Server 12 is configured to provide and receive information related to sales operations and leasing records to and from a user of computing system 24. Server 12 typically includes a proposal engine 26 and a lease engine 28. Proposal engine 26 is configured to add customer proposals to customer database 14, manage or edit existing proposals and customer information in customer database 14, and retrieve and send customer information as requested by a user. Proposal engine 26 communicates with customer database 14 and mold process database 16 so that the customer's sales process is managed and processed efficiently. Server 12 may be of any past, present, or future technology that is capable of hosting business information and performing logical operations related to medical information.

Lease engine 28 is configured to use existing customer proposal information and/or user inputs to provide an injection mold lease program to the user. The injection mold lease program may be generated by lease engine 28 based on purchase price, term of lease in time, down payment of cash, future ownership of the injection mold, interest rates or any combination thereof, that is applied to a decision table or other logical hardware. Lease engine 28 may also communicate with customer database 14 and mold process database 16 so that sales proposal and mold process information be utilized to further manage the sales and lease processes in an efficient and accurate manner.

User interface 22 is configured to facilitate communication (e.g. proposal information, customer information, mold information, lease information, etc.) between server 12 and computing system 24. Communication with the network may be achieved via IEEE 802.11 Wi-Fi, IEEE 802.3 Ethernet, modem, or any other suitable communication technology.

User interface 22 is configured to provide a graphical an interactive screen to facilitate user interaction between computing system 24 and server 12. According to various exemplary embodiments, user interface 22 may be embodied on computing system 24, on server 12, or a removable medium such as a disk or CD-ROM. Computing system 24 is configured to interact with server 12 so that the user may retrieve and manage customer data, proposal information, mold design parameters, or leasing program information. Computing system 24 may include a processor 30, an input device 32 and an output device 34. Processor 30 may be any processor capable of past, present, or future design that is capable of receiving input, providing output, and communicating with server 12. Input device 32 may include a keyboard, a mouse, a disk drive, or any other suitable computer input device or combination thereof. Output device may include a monitor, a printer, a PDA, a disk drive, or any other suitable computer output or combination thereof.

While system 10 is shown to include two remote systems in communication with each other, it is noted that in other exemplary embodiments, computing system 24 and server 12 may be integrated into a single computing system. In another exemplary embodiment, multiple computing systems 24 may be included to facilitate user interaction from multiple locations or by multiple users. In other exemplary embodiments, multiple servers 12 may be included to provide data backup, distributed processing, etc. In still other exemplary embodiments, multiple computing systems 24 and servers 12 may be used.

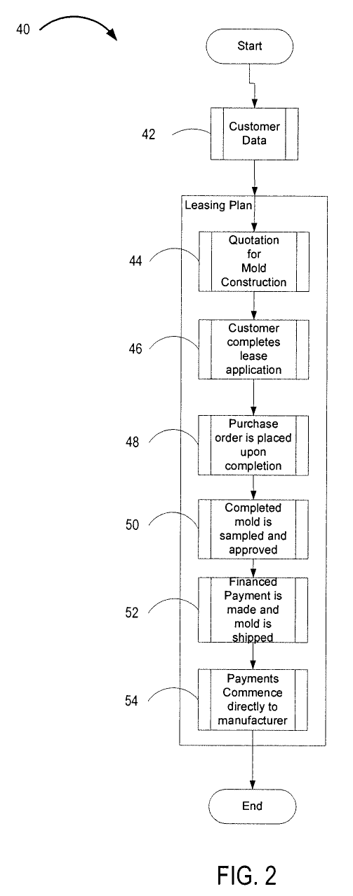

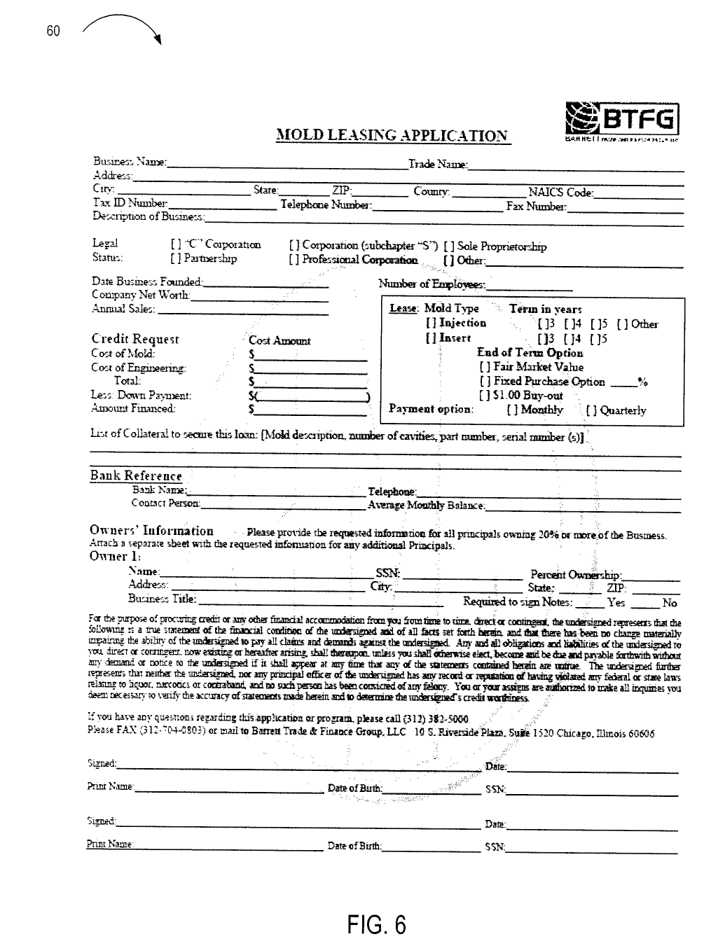

Referring to FIG. 2, a method 40 is configured to manage customer information and to generate an efficient and accurate leasing program. At a step 42, system 10 performs a customer management process. Customer information may be updated, edited, added, or deleted. At a step 44, system 10 performs a proposal for a mold construction process. Based on inputs by a user, customer system 10 may generate a proposal for a mold. At a step 46 system 10 receives customer application 60 (as shown in FIG. 6) for a lease program and records the information in a database. At a step 48, system 10 generates a purchase order based on input information gathered in step 44 and step 46. At a step 50, system 10 receives information regarding a mold generated in step 44 that has been completed and is ready for a customer to sample and approve. At a step 52, system 10 generates a lease program for a mold, notates that payment for a mold has been made, and that a mold has shipped to the customer. At a step 54, system 10 generates invoices to a customer to commence a lease program.

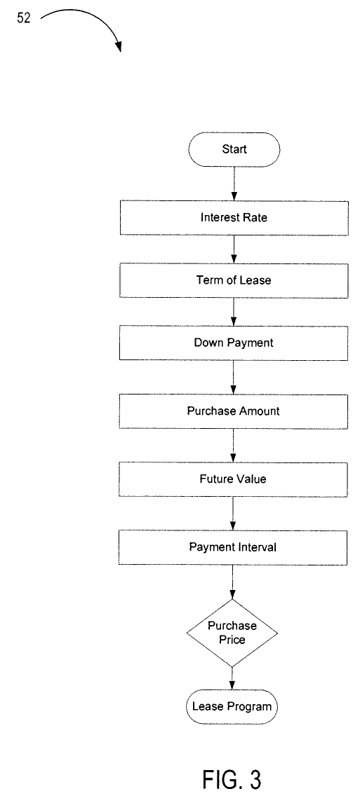

Referring to FIG. 3, further details of an exemplary embodiment of the method of FIG. 2 are shown. A process flow 52 illustrates that prior to the generation of the lease program, identification of parameters (i.e. prevailing interest rate, term of lease, down payment, payment amount, future value, and payment interval) as well as purchase price of the injection mold are factored into the final lease program generated. Once these additional parameters are be entered by the user, system 10 may generate a lease program

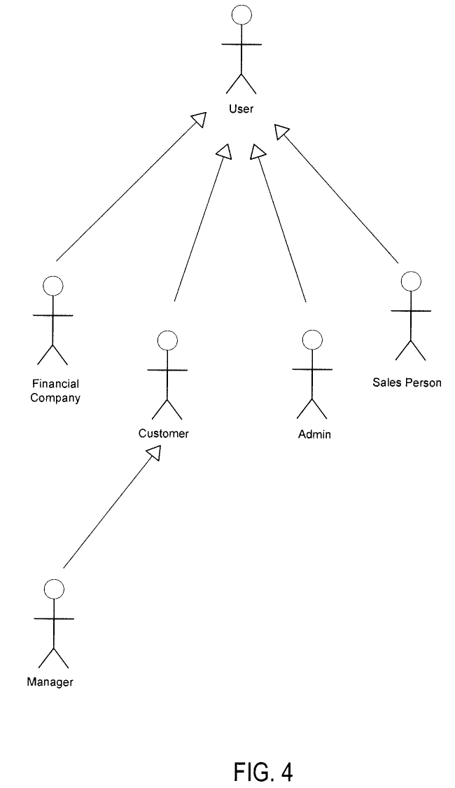

Referring to FIG. 4, system 10 may include a number of different types of users. A customer may have access to proposal information, injection mold design information, as well as lease parameter information. A financial user may have access to lease information regarding a customer lease purchase. A sales person may have access to the injection mold process and proposal information. A managerial position in the user's firm may have full access to all aspects of system 10 so that he or she may act as a source of information, troubleshooter, administrator, etc.

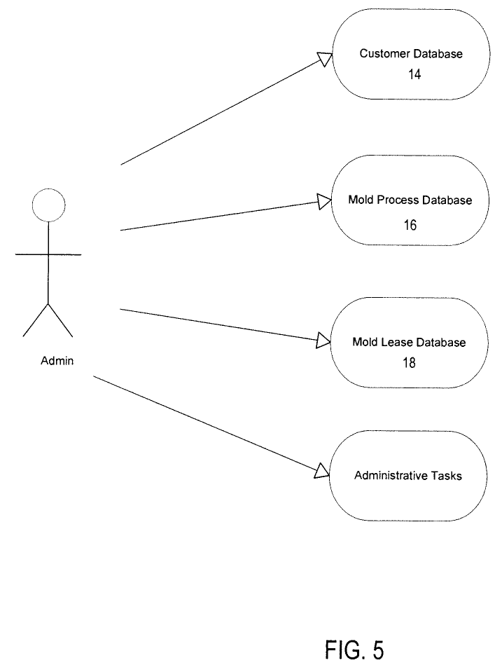

Referring to FIG. 5, a user with administrator access rights has the ability to manage various aspects of system 10 including customer database 14, mold process database 16, mold lease database 18, and user addition. Management of customer database 14 may include adding, deleting, updating customer information, or any other customer related function. Similarly, management of mold process database may include adding, deleting, updating, injection mold process 16 or any other related function. Similarly, management of mold lease database 18, may include adding, deleting, updating any function or tasks relating to mold lease database 18. In addition a user with administrative access rights may also perform other tasks as relate to user ID, password, software configuration, upgrades, etc. or any combination thereof.

Referring to FIG. 6, a mold leasing application 60 is shown. This application is intended to be completed and approved before a mold lease program is generated. Pertinent information contained within application 60 may be business name, business trade name, business street address, business city, business state, business zip code, business county, business NAICS code, business tax ID number, business telephone number, business FAX number, description of business or any combination thereof. Also included in application 60 is the legal status of the business, ownership of business, founding date of business, net worth of business, and/or business annual sales. Business application may also contain information regarding the mold lease as to type of mold, term of lease, end of term options, and/or payment interval option. Bank references may be requested as part of application 60, as well as detailed information regarding the business owner(s). Application 60 should be signed and dated with the social security number and birth date of the applicant provided.

While the exemplary embodiments illustrated in the Figures and described above are presently preferred, it should be understood that these embodiments are offered by way of example only. Accordingly, the present invention is not limited to a particular embodiment, but extends to various modifications that nevertheless fall within the scope of the appended claims. The order or sequence of any processes or method steps may be varied or re-sequenced according to alternative embodiments.

Describing the invention with Figures should not be construed as imposing on the invention any limitations that may be present in the Figures. The present invention contemplates methods, systems and program products on any machine-readable media for accomplishing its operations. The embodiments of the present invention may be implemented using an existing computer processors, or by a special purpose computer processor for an appropriate electronic medical records system, incorporated for this or another purpose or by a hardwired system.

Embodiments within the scope of the present invention may include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were shown and described in order to explain the principals of the invention and its practical application to enable one skilled in the art to utilize the invention in various embodiments and with various modifications as are suited to the particular use contemplated.

What is claimed is:

1. An apparatus for managing a lease purchase program, comprising:
a computing system;
a network;
at least one database; and
a server, wherein the server is configured to provide at least one of a mold sales proposal operation, a mold design operation, a mold construction operation, a completed mold sales operation, and a payment schedule operation for a mold.

2. The apparatus of claim 1, wherein the computing system comprises:
an output device;
a processor; and
an input device.

3. The apparatus of claim 1, wherein the at least one database includes a database selected from the group consisting of: a customer database, a mold process database and a mold lease database.

4. The apparatus of claim 1, wherein the mold is a mold selected from the group consisting of: an injection mold, an extrusion mold, a stretch mold, a powder mold, a compression mold, and a rotational mold.

5. The apparatus of claim 1, wherein the server comprises:
a lease engine configured to manage information related to sales operations and leasing records; and
a proposal engine configured to manage customer information and proposals.

6. The apparatus of claim 1, wherein the a user of the apparatus is selected from the group consisting of: a financial company, a customer, a manager, an administrator and a sales person.

7. The apparatus of claim 6, wherein an administrator is capable of managing a customer database, a mold process database, a mold lease database, and/or an administrative database.

8. The apparatus of claim 1, wherein the apparatus identifies one or more parameters selected from the group consisting of: an interest rate, a term of the lease, a down payment, a purchase amount, a future value, a payment interval and a purchase price.

9. A method for managing a lease purchase program, comprising the computer-implemented steps of:
managing customer data;
generating a proposal for a mold;
generating a lease program for a completed mold; and
generating an invoice for the completed mold.

10. The method of claim 9, wherein the lease purchase program further comprises the computer-implemented steps of:
generating a purchase order;
receiving a customer application; and
receiving information related to sampled and approved mold.

11. The method of claim 9, wherein the lease purchase program identifies one or more parameters selected from the group consisting of: an interest rate, a term of the lease, a down payment, a purchase amount, a future value, a payment interval and a purchase price.

12. The method of claim 9, wherein the method communicates with one or more databases include a database selected from the group consisting of: a customer database, a mold process database and a mold lease database.

13. The method of claim 9, wherein the mold is a mold selected from the group consisting of: an injection mold, an extrusion mold, a stretch mold, a powder mold, a compression mold and a rotational mold.

14. The method of claim 9, wherein the a user of the method is selected from the group consisting of: a financial company, a customer, a manager, an administrator and a sales person.

15. The method of claim 14, wherein an administrator is capable of managing a customer database, a mold process database, a mold lease database and/or an administrative database.

16. A lease purchase plan system for a mold, comprising:
means for managing customer data;
means for managing a lease program for the mold;
means for communicating the lease program to a customer.
